(19) United States
(12) Patent Application Publication
(10) Pub. No.: US 2012/0240231 A1
(43) Pub. Date: Sep. 20, 2012

(54) APPARATUS AND METHOD FOR DETECTING MALICIOUS CODE, MALICIOUS CODE VISUALIZATION DEVICE AND MALICIOUS CODE DETERMINATION DEVICE

(75) Inventors: Seon-Gyoung Sohn, Daejeon (KR); Beom Hwan Chang, Daejeon (KR); Jung-Chan Na, Daejeon (KR)

(73) Assignee: ELECTRONICS AND TELECOMMUNICATIONS RESEARCH INSTITUTE, Daejeon (KR)

(21) Appl. No.: 13/397,780

(22) Filed: Feb. 16, 2012

(30) Foreign Application Priority Data
Mar. 16, 2011 (KR) 10-2011-0023391

(51) Int. Cl. G06F 21/00

(52) U.S. Cl. 726/24

(57) ABSTRACT

An apparatus for detecting a malicious code includes: a malicious code visualization device for generating a graph for a malicious file by using strings in the malicious file, a connection among the strings and entropies for the strings and establishing a malicious code database with the generated graph for the malicious file. The apparatus further includes a malicious code determination device for generating a graph for a specific executable file and comparing the graph for the executable file with graphs for malicious files stored in the malicious code database to detect a malicious code in the executable file.

### CROSS-REFERENCE(S) TO RELATED APPLICATION(S)

The present invention claims priorities of Korean Patent Application No. 10-2011-0023391, filed on Mar. 16, 2011, which is incorporated herein by reference.

### FIELD OF THE INVENTION

The present invention relates to expression and detection of a malicious code, and more particularly, an apparatus and a method for detecting a malicious code by visualizing a form, a structure and a characteristic of a malicious file to generate a graph thereof and visualizing a specific executable file to form a graph thereof and then measuring similarities between the graphs to determine that the executable file has a malicious code.

### BACKGROUND OF THE INVENTION

Computer viruses have been developed into various types, starting from a file infecting virus to a worm virus using a network for rapid spreading and a Trojan horse virus for data leakage. The threat of these malicious codes is on an increasing trend year to year. Even from the technical perspective, the risk of the malicious codes is more increasing, thus actually making computer users feel uneasy. To solve this problem, various approaches to protect computer systems from threatening of new malicious codes are being actively studied.

Most of anti-virus software known to date use a file-based diagnosis, which is a method using a signature in a specific format, so it is called as a signature-based or string scanning method. Since such signature-based diagnosis targets on only a specific portion or unique portion of a file sorted as a malicious code for scanning, mis-detection or non-detection can be minimized. Further, upon file scanning, the comparison of only specific portions of files allows for fast scanning. However, this method can merely handle malicious codes that have been already known, and thus, it is unable to cope with new forms of malicious codes that have been unknown yet.

One of detection methods developed for overcoming the limitation of the signature-based diagnosis is a heuristic detection technique. This designates instructions of general malicious codes, e.g., file writing in a specific folder and a specific registry change, as heuristic signatures and compares the heuristic signatures with instructions for files to be scanned. The heuristic detection technique is classified into a method actually executed in a virtual operating system, and a method of scanning and comparing files themselves without execution.

Besides, an operation code (OPcode) instruction comparison method for a common code section of malicious files is often used. These methods are able to detect even unknown malicious codes but should actually previously collect information regarding instructions within files, which may be easy to cause system load during execution. Thus, an analysis technique for minimizing the load while executing an efficient detection for unknown malicious codes is required.

### SUMMARY OF THE INVENTION

In view of the above, the present invention provides an apparatus and a method for detecting a malicious code by visualizing a form, a structure and a characteristic of a malicious file to generate a graph thereof by a malicious code visualization device and visualizing a specific executable file to form a graph thereof by a malicious code determination device and then measuring similarities between the graphs to determine that the executable file has a malicious code.

In accordance with an aspect of the present invention, there is provided a malicious code visualization device including: a string extracting unit for unpacking a file containing a malicious code depending on whether or not the file is in a packed status, and extracting at least two strings from the file; an entropy calculating unit for calculating an entropy for each of the extracted strings; and a graph generating unit for setting the strings to nodes, respectively, setting directionalities of the nodes based on a connection among the respective strings, and setting colors of the nodes based on the entropies for the strings to generate a graph for the file.

In accordance with another aspect of the present invention, there is provided a malicious code determination device using a malicious code database that stores graphs for files containing malicious codes. The device includes: a data extracting unit for extracting strings from a certain executable file and calculating entropies for the strings; a data indicating unit for setting the strings to nodes, setting directionalities of the nodes based on a connection among the respective strings, and setting colors of the nodes based on the entropies for the strings to generate a graph for the executable file; and an analyzing unit for comparing the graph for the executable file with the graphs stored in the malicious code database to determine whether or not the executable file has a malicious code.

In accordance with still another aspect of the present invention, there is provided an apparatus for detecting a malicious code including: a malicious code visualization device for generating a graph for a malicious file by using strings in the malicious file, a connection among the strings and entropies for the strings, and establishing a malicious code database with the generated graph for the malicious file; and a malicious code determination device for generating a graph for a specific executable file and comparing the graph for the executable file with graphs for malicious files stored in the malicious code database to detect a malicious code in the executable file.

In accordance with still another aspect of the present invention, there is provided a method for detecting a malicious code including: generating a graph for a malicious file by using strings in the malicious file, a connection among the strings and entropies for the strings, and establishing a malicious code database with the generated graph for the malicious file; generating a graph for the executable file and comparing the graph for the executable file with graphs for malicious files stored in the malicious code database to detect a malicious code in the executable file.

### BRIEF DESCRIPTION OF THE DRAWINGS

The objects and features of the present invention will become apparent from the following description of embodiments, given in conjunction with the accompanying drawings, in which:

FIG. 1 is a block diagram of an apparatus for detecting malicious code in accordance with an embodiment of the present invention;

FIG. 2 is a block diagram illustrating a malicious code visualization device for visualizing a malicious file in accordance with the embodiment of the present invention;

FIG. 3 is a view showing a structure of a graph generated by the malicious code visualization device in accordance with the embodiment of the present invention;

FIG. 4 is a block diagram illustrating a malicious code determination device for determining whether an executable file has a malicious code or not in accordance with the embodiment of the present invention; and

FIG. 5 is a flowchart illustrating a procedure of detecting a malicious code and updating a malicious code database using the malicious code detecting apparatus in accordance with an embodiment of the present invention.

### DETAILED DESCRIPTION OF THE EMBODIMENTS

Hereinafter, an apparatus and a method for detecting malicious code in accordance with embodiments of the present invention will be described in detail with the accompanying drawings.

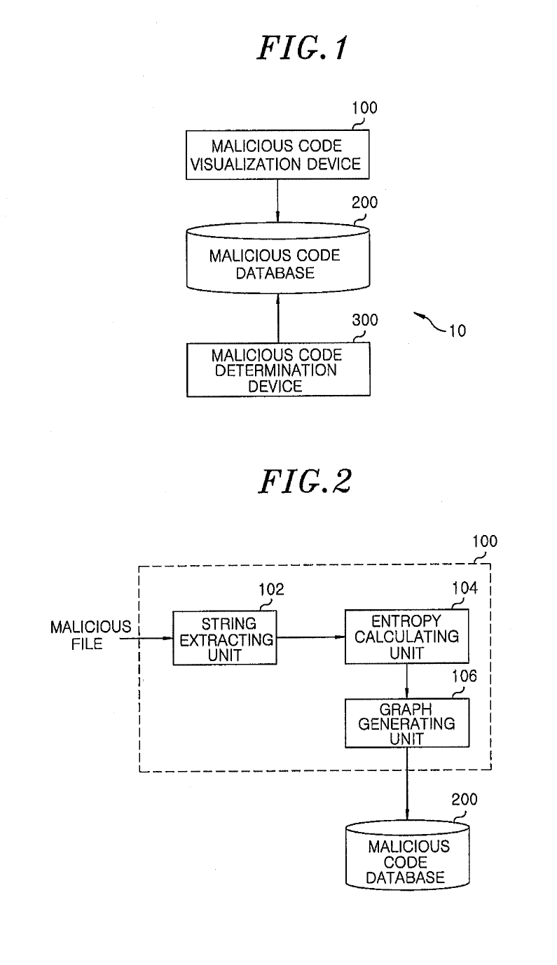

FIG. 1 is a block diagram showing an apparatus for detecting a malicious code in accordance with the embodiment of the present invention.

The malicious code detecting apparatus 10 includes: a malicious code visualization device 100; a malicious code database 200 and a malicious code determination device 300.

The malicious code visualization device 100 visualizes an executable file having a malicious code (i.e., a malicious file) as a graph and establishes the malicious code database 200 by storing the graph therein.

The malicious code determination device 300 generates a graph of an executable file to be determined whether it has a malicious code or not and compares the graph of the executable file with graphs stored in the malicious code DB 200, thereby determining whether the executable file has the malicious code or not.

Hereinafter, detailed configurations of the malicious code visualization device 100 and the malicious code determination device 300 will be described.

FIG. 2 is a block diagram showing the malicious code visualization device 100 for visualizing a malicious code and establishing the malicious code database 200 in accordance with the embodiment of the present invention.

As shown in FIG. 2, the malicious code visualization device 100 includes a string extracting unit 102, an entropy calculating unit 104 and a graph generating unit 106. The malicious code visualization device 100 operates cooperatively with the malicious code database 200. That is, the malicious code visualization device 100 executes a visualization task for files containing malicious codes by using each of the components and stores the visualized information in the malicious code database 200.

Depending on whether or not an executable file containing a malicious code is in a packed status, the string extracting unit 102 may unpack the executable file when the file is in the packed status. Then, the string extracting unit 102 extracts at least two strings from the unpacked file. Herein, the strings include instructions for executing the executable file and show a sequence thereof. The strings extracted by the string extracting unit 102 are provided to the entropy calculating unit 104.

The entropy calculating unit 104 calculates an entropy for each string to forward the same to the graph generating unit 106. The entropy may include a length, a pattern, a frequency or the like of each string.

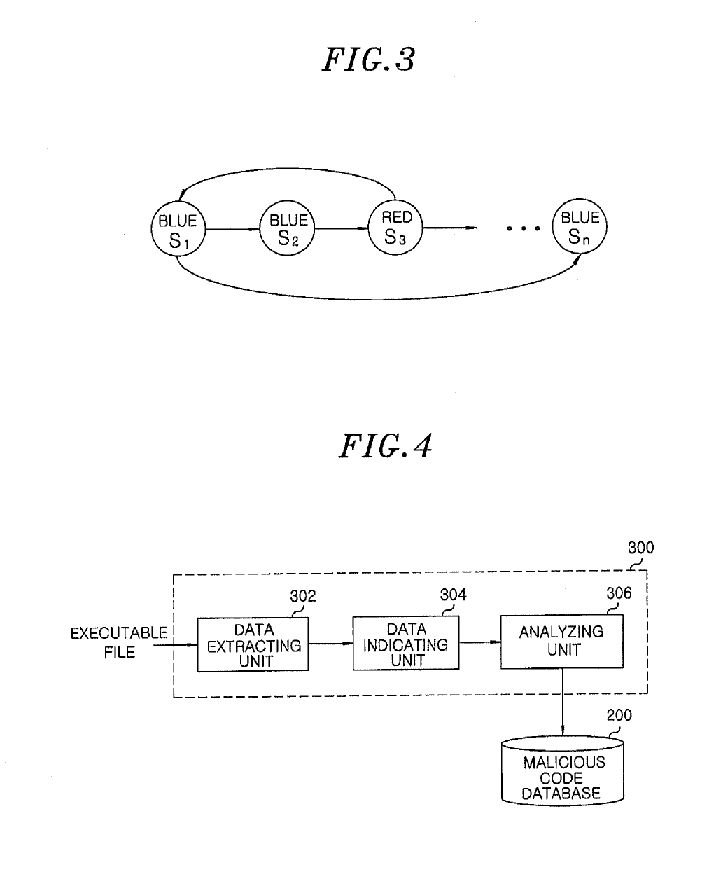

The graph generating unit 106 sets the strings to nodes, sets directionalities thereof based on a connection among the strings and determines a color of each node based on the entropy to generate a graph. In other words, as shown in FIG. 3, the strings are respectively set to nodes S1, S2, S3, . . . , Sn, the connections among the nodes are set by using arrows indicating directions, and colors of the nodes are set based on the entropies for the strings, thereby generating a graph for the executable file containing a malicious code. Herein, the color of each node is set with a preset color which corresponds with an entropy value of the string in the node.

The thusly-generated graph for each malicious executable file is stored in the malicious code database 200.

In accordance with the embodiment of the present invention, the executable files containing malicious codes can be expressed by visualizing a form, a structure, a characteristic or the like thereof, thereby facilitating indication of a structure, a form, a behavior or the like of the malicious executable files for easy understanding.

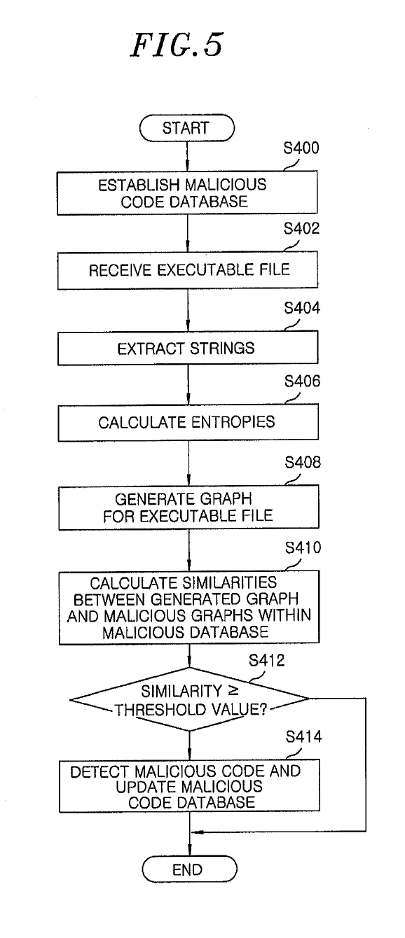

FIG. 4 is a block diagram illustrating a malicious code determination device 300 in accordance with the embodiment of the present invention.

As shown in FIG. 4, the malicious code determination device 300 includes a data extracting unit 302, a data indicating unit 304 an analyzing unit 306 and the like.

Depending on whether or not a certain executable file is in a packed status, the data extracting unit 302 unpacks a packed executable file and extracts strings from the unpacked executable file. Then the data extracting unit 302 calculates entropies for the respective extracted strings. Herein, the entropy includes a length, a pattern, a frequency or the like of each string.

The data indicating unit 304, as shown in FIG. 3, sets the strings to nodes, respectively, sets directionalities of the nodes based on connections among the strings and determines a color of each node based on the entropy, thereby generating a graph for the executable file.

The data extracting unit 302 and the data indicating unit 304 may be implemented by the malicious code visualization device 100 as shown in FIG. 1. That is, the malicious code visualization apparatus 100 may be used to generate the graph for the executable file.

The analyzing unit 306 compares the graph generated by the data indicating unit 304 with the data (graphs) stored in the malicious code database 200. When a graph having similarity with the graph corresponding to the executable file more than a preset threshold value is present in the malicious code database 200, the analyzing unit 306 determines that the executable file has a malicious code. Thus, the analyzing unit 306 can detect an existence of a malicious code in the executable file.

Further, when it is detected that the malicious code is present in the executable file, the analyzing unit 306 updates the data stored in the malicious code database 200 by using the graph for the executable file. In other words, the analyzing unit 306 updates the graph (i.e., the graph having similarity more than a threshold value with the graph for the executable file) within the malicious code database 200 by using the graph for the executable file or add the graph for the executable file to the malicious code database 200.

Hereinafter, a process in which the malicious code detecting apparatus 10 with the foregoing configuration detects a malicious code and updates the malicious code database will be described with reference to FIG. 5.

FIG. 5 is a flowchart illustrating a process in which the malicious code detecting apparatus in accordance with the embodiment of the present invention detects a malicious code and updates the malicious code database.

First, the malicious code visualization device 100 is used to generate graphs for executable files containing malicious codes, and establishes a malicious code database 200 by using the generated graphs in step S400.

Upon receipt of an executable file in step S402, the data extracting unit 302 in the malicious code determination unit 300 extracts strings from the executable file and calculates entropies for the extracted strings in steps S404 and S406. Here, when the executable file is in a packed status, the data extracting unit 302 extracts the strings after unpacking the packed executable file, and calculates the entropies, such as length, pattern, frequency, or the like of the strings. The calculated entropies and the strings may be forwarded to the data indicating unit 304.

The data indicating unit 304 sets the strings to nodes, sets directionalities (arrows) of the nodes based on a connection among the strings, determines a color of each node based on the entropy and generates a graph for the executable file in step S408. The generated graph is provided to the analyzing unit 306.

Thereafter, the analyzing unit 306 compares the graph for the executable file with malicious code graphs stored in the malicious code database 200 to calculate similarities therebetween in step S410.

Next, the analyzing unit 306 determines whether or not there is a graph has similarity with the graph for the executable file more than a preset threshold value in the malicious code database 200 in step S412.

If there is such graph as a result of the determination in step S412, the analyzing unit 320 determines that the executable file has a malicious code and updates the malicious code database 200 by using the graph for the executable file in step S414. With this, the malicious code in the executable file is detected.

In accordance with the malicious code detecting method of the embodiment of the present invention, information regarding an executable file can be visualized, and similarities among the graph for the executable file and graphs for malicious files stored in the malicious code database 200 can be measured based on the visualized information, thereby detecting a malicious code, which results in facilitating determination of malicious code patterns.

In addition, in accordance with the present invention, executable files containing malicious codes can be expressed by visualizing a form, a structure, a characteristic or the like of the executable files, thereby facilitating indication of a structure, a form, a behavior or the like of the malicious executable files.

While the invention has been shown and described with respect to the specific embodiments, it will be understood by those skilled in the art that various changes and modification may be made without departing from the scope of the invention as defined in the following claims.

What is claimed is:

1. A malicious code visualization device comprising:
a string extracting unit for unpacking a file containing a malicious code depending on whether or not the file is in a packed status, and extracting at least two strings from the file;
an entropy calculating unit for calculating an, entropy for each of the extracted strings; and
a graph generating unit for setting the strings to nodes, respectively, setting directionalities of the nodes based on a connection among the respective strings, and setting colors of the nodes based on the entropies for the strings to generate a graph for the file.

2. The device of claim 1, wherein the entropy calculating unit calculates the entropy for the string by using a length, a pattern or a frequency of the string.

3. A malicious code determination device using a malicious code database that stores graphs for files containing malicious codes, the device comprising:
a data extracting unit for extracting strings from a certain executable file and calculating entropies for the strings;
a data indicating unit for setting the strings to nodes, setting directionalities of the nodes based on a connection among the respective strings, and setting colors of the nodes based on the entropies for the strings to generate a graph for the executable file; and
an analyzing unit for comparing the graph for the executable file with the graphs stored in the malicious code database to determine whether or not the executable file has a malicious code.

4. The device of claim 3, wherein, in comparing the graph for the executable file with the graphs stored in the malicious code database by the analyzing unit, when a graph having similarity with the graph for the executable file more than a preset threshold value is present in the malicious code database, the analyzing unit determines that the executable file has a malicious code.

5. The device of claim 3, wherein when it is determined that the executable file has the malicious code, the analyzing unit updates the malicious code database with the graph for the executable file.

6. The device of claim 3, wherein the data extracting unit calculates the entropies for the strings by using a length, a pattern, or a frequency of each of the strings.

7. An apparatus for detecting a malicious code comprising:
a malicious code visualization device for generating a graph for a malicious file by using strings in the malicious file, a connection among the strings and entropies for the strings, and establishing a malicious code database with the generated graph for the malicious file; and
a malicious code determination device for generating a graph for a specific executable file and comparing the graph for the executable file with graphs for malicious files stored in the malicious code database to detect a malicious code in the executable file.

8. The apparatus of claim 7, wherein the malicious code visualization device includes:
a string extracting unit for unpacking the malicious file depending on whether or not the file is in a packed status, and extracting at least two strings from the malicious file;
an entropy calculating unit for calculating the entropies for the extracted strings; and
a graph generating unit for respectively setting the strings to nodes, setting directionalities of the nodes based on the connection among the respective strings, and setting colors of the nodes based on the entropies for the strings to generate a graph for the malicious file.

9. The apparatus of claim 8, wherein the entropy calculating unit calculates the entropies for the strings by using a length, a pattern or a frequency of each of the strings.

10. The apparatus of claim 7, wherein the malicious determination device includes:
a data extracting unit for extracting strings from the executable file and calculating entropies for the strings;
a data indicating unit for setting the strings to nodes, setting directionalities of the nodes based on a connection among the respective strings, and setting colors of the nodes based on the entropies for the strings to generate the graph for the executable file; and
an analyzing unit for comparing the graph for the executable file with the graphs stored in the malicious code database and when a graph having similarity with the graph for the executable file more than a preset threshold value is present in the malicious code database, the analyzing unit determines that the executable file a the malicious code.

11. The apparatus of claim 10, wherein when it is determined that the executable file has the malicious code, the analyzing unit updates the malicious code database with the graph for the executable file.

12. The apparatus of claim 10, wherein the data extracting unit calculates the entropies for the strings by using a length, a pattern or a frequency of each of the strings.

13. A method for detecting a malicious code comprising:
generating a graph for a malicious file by using strings in the malicious file, a connection among the strings and entropies for the strings, and establishing a malicious code database with the generated graph for the malicious file; and
generating a graph for the executable file and comparing the graph for the executable file with graphs for malicious files stored in the malicious code database to detect a malicious code in the executable file.

14. The method of claim 13, wherein said generating the graph for the malicious file includes:
when the malicious file is in a packed status, unpacking the malicious file, and extracting at least two strings form the malicious file;
calculating the entropies for the extracted strings; and
setting the strings to nodes, respectively, setting directionalities of the nodes based on the connection among the respective strings, and setting colors of the nodes based on the entropies for the strings to generate the graph for the malicious file.

15. The method of claim 14, wherein the entropies for the strings are calculated by using a length, a pattern or a frequency of each of the strings.

16. The method of claim 13, wherein said generating the graph for the executable file includes:
extracting strings from the executable file in response to receipt of the executable file and calculating entropies for the strings; and setting the strings to nodes, setting directionalities of the nodes based on a connection among the respective strings, and setting colors of the nodes based on the entropies for the strings to generate the graph for the executable file, and
wherein said comparing the graph includes:
calculating similarities between the generated graph for the executable file and the graphs stored in the malicious code database; and determining that the executable file has a malicious code when a graph having similarity with the graph for the executable file more than a preset threshold value is present in the malicious code database.

17. The method of claim 16, further comprising:
when it is determined that the executable file has the malicious code, updating the malicious code database with the graph for the executable file.

18. The method of claim 16, wherein the entropies for the strings are calculated by using a length, a pattern or a frequency of each of the strings.
